(19) United States
(12) Patent Application Publication
(10) Pub. No.: US 2025/0239671 A1
(43) Pub. Date: Jul. 24, 2025

(54) BATTERY MANUFACTURING METHOD AND BATTERY MANUFACTURING SYSTEM

(71) Applicant: LG ENERGY SOLUTION, LTD., Seoul (KR)

(72) Inventors: Min Kyu SIM, Daejeon (KR); Jee Yeon KOH, Daejeon (KR); Min Su KIM, Daejeon (KR); Jong Seok PARK, Daejeon (KR); June Hee KIM, Daejeon (KR); Jong Kwon SHIN, Daejeon (KR)

(21) Appl. No.: 18/607,003

(22) Filed: Mar. 15, 2024

(30) Foreign Application Priority Data
Jan. 24, 2024 (KR) 10-2024-0010828
Jan. 29, 2024 (KR) 10-2024-0013083

(51) Int. Cl. H01M 10/48; H01M 4/04; H01M 10/42

(52) U.S. Cl. CPC H01M 10/488; H01M 4/04; H01M 10/4221

(57) ABSTRACT

A method of manufacturing a battery includes generating pattern indicator data that includes representing a plurality of positions at a patterned electrode sheet in which coated portions and uncoated portions are repeatedly arranged, and a coated portion and an uncoated portion adjacent to the coated portion constituting a pattern, where a position of the plurality of positions being a position of at least one coated portion and an adjacent uncoated portion at the patterned electrode sheet. The method includes generating measurement data and/or inspection data for the patterned electrode sheet; associating the generated measurement data and/or inspection data with the pattern indicator data; and generating monitoring data for manufacturing the battery based on the associated measurement data and/or inspection data and the pattern indicator data.

### CROSS-REFERENCE TO RELATED APPLICATIONS

The present application claims priority to KR Priority Document KR 10-2024-0010828, filed on Jan. 24,2024, and KR Priority Document KR 10-2024-0013083,filed Jan. 29,2024, the contents of which are all hereby incorporated by reference herein in their entirety.

### TECHNICAL FIELD

The present disclosure relates to a battery manufacturing method and a battery manufacturing system.

### BACKGROUND

Unlike primary batteries, secondary batteries can be charged or discharged a plurality of times. Secondary batteries are widely used as energy sources for various wireless devices such as handsets, notebook computers, cordless vacuum cleaners, and the like. Recently, the manufacturing cost per unit capacity of a secondary battery has been significantly reduced due to improvements in energy density and economies of scale, and as the traveling distance of a battery electric vehicle (BEV) increases to the same level as that of a fuel vehicle, the main use of secondary battery is shifting from a mobile device to mobility.

A secondary battery is manufactured through an electrode process, an assembly process, and an activation process. Among the above processes, the electrode process is the most critical process in determining the yield and performance of battery cells. The electrode process may include a coating process, a roll pressing process, and a slitting process. In the coating process, a surface of a current collector may be coated with an active material and an insulating material. In the roll pressing process, an electrode may be pressed by pressing rolls. The roll pressing process may determine the density, performance, and surface quality of the electrode. In the slitting process, the electrode may be cut into a plurality of electrodes depending on the battery cell design.

### SUMMARY

The present disclosure is directed to providing a battery manufacturing method and battery manufacturing system with improved quality traceability and data match in a battery manufacturing process using patterned electrodes.

An exemplary battery manufacturing method of the present disclosure for solving the above problems may include generating pattern indicator data that includes representing a plurality of positions at a patterned electrode sheet in which coated portions and uncoated portions are repeatedly arranged, and a coated portion and an uncoated portion adjacent to the coated portion constituting a pattern, where a position of the plurality of positions being a position of at least one coated portion and an adjacent uncoated portion at the patterned electrode sheet, generating measurement data and/or inspection data for the patterned electrode sheet, associating the generated measurement data and/or inspection data with the pattern indicator data; and generating monitoring data for manufacturing a battery based on the associated measurement data and/or inspection data and the pattern number data.

One or more non-transitory processor-readable mediums storing executable instructions therein, which when executed by one or more processors, may causes the one or more processors to perform the above method.

The pattern indicator data may include the pattern indicators and time values matched to the pattern indicators, the measurement data and/or inspection data may include measurement values and/or inspection values, and time values matched to the measurement values and/or inspection values, and the pattern indicators and the measurement values and/or inspection values may be associated with each other by corresponding to the same time value.

According to an exemplary embodiment, the pattern indicator data may include pattern indicators, and a method may include matching the pattern indicators with the positions of the plurality of positions at the patterned electrode, where a pattern indicator may be acquired by counting a position, and a count may increase or decrease with the pattern indicator.

The battery manufacturing method may include determining a pattern of an abnormal pitch by comparing a length of the pattern with a set pattern pitch.

The length of a pattern may be derived by multiplying a difference between a boundary detection time point of a beginning of a coated portion and a boundary detection time point of an end of an uncoated portion included in the pattern with a moving speed of the patterned electrode sheet.

The length of a coated portion included in the pattern may be derived by multiplying a difference between a boundary detection time point of a beginning of a coated portion and a boundary detection time point of an end of the coated portion with a moving speed of the patterned electrode sheet.

According to an exemplary embodiment of the present disclosure, the battery manufacturing method may include acquiring coordinate data including coordinate values indicating positions of the patterned electrode sheet, where the coordinate values may be associated with one or more of the following: i) the pattern indicators; ii) the measurement values and/or inspection values; and iii) the time values matched to the pattern indicators and the measurement values and/or inspection values.

Sub-pattern indicators may be obtained by comparing the coordinate data with a set pattern pitch.

The battery manufacturing method may include determining whether a pattern has an abnormal pitch by comparing a length of the pattern with a set pattern pitch, where the length of the pattern is derived by a difference in a coordinate value between a start point of a beginning of a coated portion and a coordinate value of an end point of an uncoated portion included in the pattern.

The method may include deriving a length of a coated portion included in the pattern by a difference in a coordinate value between a start point of a beginning of a coated portion and a coordinate value of an end point of the coated portion.

According to an exemplary embodiment, when an uncoated section not included in the pattern exists between neighboring patterns of the patterned electrode sheet, a pattern indicator may be assigned to the uncoated section by the number of patterns obtained by dividing a length of the uncoated section by a set pattern pitch.

The monitoring data may include a roll map including the pattern indicator data and the measurement data and/or inspection data associated with the pattern indicators, and optionally further include coordinate data.

A battery manufacturing system according to another aspect of the present disclosure may include a first position measuring device configured to generate pattern indicator data that includes representing a plurality of positions at a patterned electrode sheet in which coated portions and uncoated portions are repeatedly arranged, and a coated portion and an uncoated portion adjacent to the coated portion constituting a pattern, where a position of the plurality of positions being a position of at least one coated portion and an adjacent uncoated portion at the patterned electrode sheet, a measuring device and/or inspecting device configured to collect measurement data and/or inspection data for the patterned electrode sheet, and a server configured to generate monitoring data for manufacturing a battery based on the pattern indicator data and the measurement data and/or inspection data associated with the pattern indicator data.

The battery manufacturing system may include one or more processors; the first position measuring device configured to generate the pattern indicator data including pattern indicators and time values matched to the pattern indicators; the measuring device and/or inspecting device configured to generate the measurement values and/or inspection values, and time values matched to the measurement values and/or inspection values; where the one or more processors are configured to associate the pattern indicators and the measurement values and/or inspection values with each other by corresponding to the same time value.

The first positioning measuring device may be configured to generate the pattern indicator data including pattern indicators matching with the positions of the plurality of positions at the patterned electrode sheet, where a pattern indicator may be generated by counting a position, and the count increases or decreases with the pattern indicator.

The first position measuring device may be configured to determine whether a pattern has an abnormal pitch by comparing a length of the pattern with a set pattern pitch.

The battery manufacturing system may include a controller configured to control the movement of the patterned electrode sheet between the unwinder and the rewinder. The association of the pattern indicators with the measurement data and/or inspection data may be performed by the measuring device and/or inspecting device or the controller.

The battery manufacturing system according to an exemplary embodiment may further include a second position measuring device configured to generate coordinate data including coordinate values indicating positions of the patterned electrode sheet, where the coordinate values may be associated with one or more of the following: i) the pattern indicators; ii) measurement values and/or inspection values included in the measurement data and/or inspection data; and iii) time values matched to the pattern indicators and the measurement values and/or inspection values.

The server may generate a roll map configured to include the pattern indicator data and the measurement data and/or inspection data associated with the pattern indicators, and optionally further include coordinate data.

The roll map may include at least one of information about a pattern of an abnormal pitch that is different from a set pattern pitch and information about an uncoated section that is located between neighboring patterns of the patterned electrode sheet and is not included in the pattern.

The information about the uncoated section may be information about pattern indicators assigned to the uncoated section by the number of patterns obtained by dividing a length of the uncoated section by the set pattern pitch.

According to an exemplary embodiment of the present disclosure, a battery may include an electrode having at least one coated portion and an adjacent uncoated portion represented by a pattern indicator of pattern indicator data that represents a plurality of positions at a roll map stored in a memory, the roll map representing a patterned electrode sheet in which coated portions and uncoated portions are repeatedly arranged, the roll map providing measurement data and/or inspection data of the coated portions at the represented pattern electrode sheet, and the pattern indicator indicating the position of at least one coated portion and the adjacent uncoated portion at the roll map corresponding to the electrode; and a casing in which the electrode is contained, the casing including a cell ID, and the cell ID identifying the pattern indicator for retrieving measurement data and/or inspection data of the at least one coated portion at the represented electrode sheet corresponding to the pattern indicator.

According to the present disclosure, it may be possible to generate monitoring data for manufacturing a battery by using data in which a pattern indicator of a patterned electrode is reflected.

Accordingly, it may be possible to monitor battery manufacturing processes to correspond to the state of an actual patterned electrode, thereby improving quality traceability and data match.

Furthermore, according to the present disclosure, it may be possible to acquire coordinate data in addition to pattern indicator data. Therefore, monitoring data including both pattern indicators and coordinate values may be generated, thereby further improving the accuracy of the monitoring data.

Effects obtainable in exemplary embodiments of the present disclosure are not limited to the effects described above, and other effects that are not described may be clearly derived and understood by those skilled in the art from the following detailed descriptions to which the exemplary embodiments of the present disclosure pertain. That is, unintended effects resulting from implementing exemplary embodiments of the present dislcosure may also be derived by those skilled in the art from the exemplary embodiments of the present disclosure.

### BRIEF DESCRIPTION OF THE DRAWINGS

FIG. 1 illustrates a battery manufacturing system according to an exemplary embodiment of the disclosure.

FIGS. 2A and 2B illustrate a visualized roll map and patterned electrodes according to an exemplary embodiment of the disclosure.

FIG. 3 is a flowchart illustrating a battery manufacturing method according to an exemplary embodiment of the disclosure.

FIG. 4 illustrates a roll map of a patterned electrode sheet in which loading amount measurement data is arranged over time according to an exemplary embodiment of the disclosure.

FIG. 5 illustrates a battery manufacturing system according to another exemplary embodiment of the disclosure.

FIG. 6 is a flowchart illustrating a battery manufacturing method according to another exemplary embodiment of the disclosure.

FIG. 7 illustrates a roll map of a patterned electrode sheet on which pattern indicators and sub-pattern indicators are marked according to an exemplary embodiment of the disclosure.

FIG. 8 illustrates a battery manufacturing system according to yet another exemplary embodiment of the disclosure.

FIG. 9 illustrates pattern indicator data and coordinate data marked on a patterned electrode sheet with patterned electrodes formed on the upper and lower surfaces thereof according to an exemplary embodiment of the disclosure.

FIG. 10 illustrates a roll map in which pattern indicator data and coordinate data are marked in a coated section and an uncoated section according to an exemplary embodiment of the disclosure.

### DETAILED DESCRIPTION

Hereinafter, exemplary embodiments of the present disclosure will be described in detail with reference to the accompanying drawings. Prior to this, terms and words used in this specification and claims should not be interpreted as being limited to commonly used meanings or meanings in dictionaries and should be interpreted with meanings and concepts which are consistent with the technological scope of the present disclosure based on the principle that the inventors have appropriately defined concepts of terms in order to describe the present disclosure in the best way.

Therefore, since the embodiments described in this specification and configurations illustrated in the drawings are only exemplary embodiments and do not represent the overall technological scope of the present disclosure, it is understood that the present disclosure covers various equivalents and modifications that are substitutable at the time of filing of this application.

In addition, in the description of the present disclosure, when it is determined that detailed descriptions of related well-known configurations or functions unnecessarily obscure the gist of the present disclosure, the detailed descriptions thereof may be omitted.

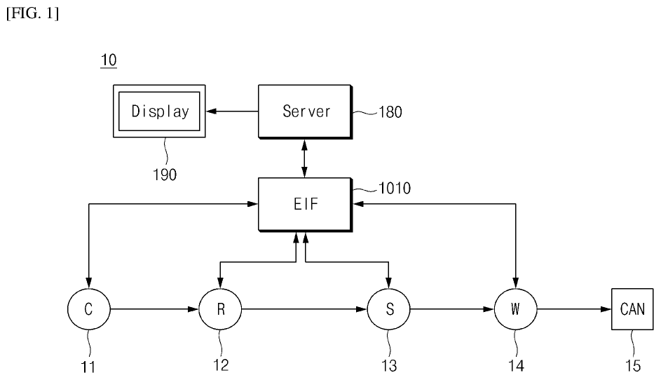

Since the embodiments of the present disclosure are provided to more completely explain the present disclosure to those skilled in the art, the shapes and sizes of components in the drawings may be exaggerated, omitted, or schematically illustrated for clearer description. Therefore, the size or ratio of each component may not entirely reflect the actual size or ratio. FIG. 1 illustrates a battery manufacturing system 10 according to an exemplary embodiment of the present disclosure.

Referring to FIG. 1, the battery manufacturing system 10 may include a coating device 11, a roll pressing device 12, a slitting device 13, a winding device 14, a relay server (event integration facility (EIF)) 1010, a server 180, and a display device 190.

The battery manufacturing system 10 may be configured to manufacture battery cells (e.g., cylindrical battery cells, prismatic battery cells, or pouch cells) by performing a series of roll-to-roll processes. An electrode sheet unwound from an input electrode roll may be processed by any one of a die coater of the coating device 11, pressure rolls of the roll pressing device 12, and a slitting knife of the slitting device 13, and the processed electronic sheet may be wound into an electrode roll. Accordingly, the processing of the coating device 11, the roll pressing device 12, and the slitting device 13 for the production of battery electrodes may be referred to as a roll-to-roll process. The winding device 14 may wind together a first electrode sheet (e.g., negative electrode sheet) unwound from a first electrode roll (e.g., negative electrode roll), a second electrode sheet (e.g., positive electrode sheet) unwound from a second electrode roll (e.g., positive electrode roll), and one or more separator sheets unwound from one or more separator rolls.

The EIF 1010 may be a device for communication between process controllers of a manufacturing facility and the server 180. The EIF 1010 may receive the process event data occurring in the coating device 11, the roll pressing device 12, the slitting device 13, and the winding device 14, and communicate the received process event data to the server 180.

If necessary, each process controller and the server 180 may communicate directly. Accordingly, process event data occurring in the coating device 11, the roll pressing device 12, the slitting device 13, and the winding device 14 may each be transmitted to the server 180.

The server 180 may generate monitoring data for manufacturing a battery. Typically, the monitoring data may include a roll map including process event data. Data of the roll map may include data indicating process events and coordinate values matched with the data. The coordinate values may indicate positions on the electrode. The server 180 may transmit a visualization command to the display device 190, and the display device 190 may visualize the roll map and display the visualized roll map (VRM).

The server 180 may generate and store the roll map of each process (e.g., the coating process, the roll pressing process, or the slitting process).

The roll map may be a type of mock electrode that imitates a moving real electrode (e.g., a real electrode moving between an unwinder and a rewinder).

Referring again to FIG. 1, an electrode assembly manufactured by being wound in the winding device 14 may be transferred and accommodated in a case such as a can 15. A can ID, which is separate can ID information, may be assigned to the can, and may be a type of battery cell ID. Accordingly, it may be possible to search for historical data on the manufacture of the battery cells based on the can ID.

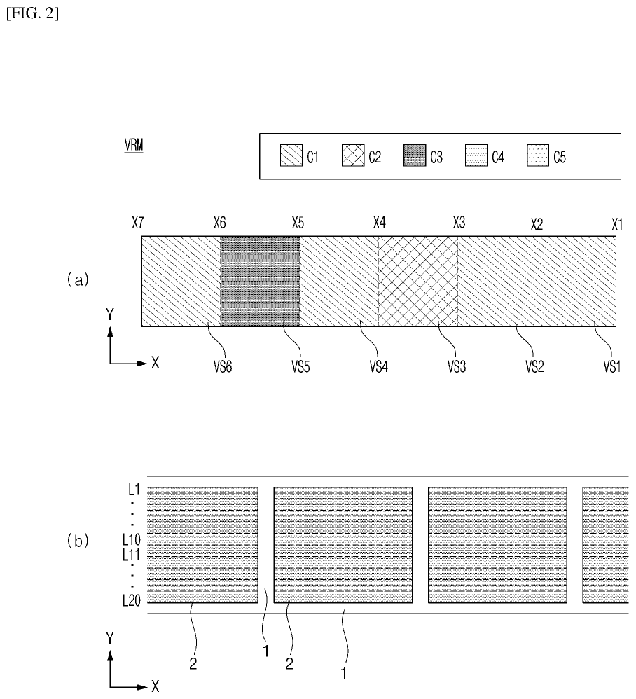

FIGS. 2A and 2B illustrate a visualized roll map and patterned electrodes according to an exemplary embodiment of the present disclosure.

In FIGS. 2A and 2B, arrow X indicates a longitudinal direction (traveling direction) of an electrode sheet (roll map), and arrow Y indicates a width direction of the electrode sheet (roll map).

The visualized roll map (VRM) of FIG. 2A may include a plurality of visualization sections VS1, VS2, VS3, VS4, VS5, and VS6 corresponding to a plurality of sections of the electrode sheet. Each of the plurality of visualization sections VS1, VS2, VS3, VS4, VS5, and VS6 may include start coordinates, end coordinates, and color.

For example, a representative value of measurement data CMD associated with the coordinates of the visualization sections VS1, VS2, VS4, and VS6 may be displayed in color C1, a representative value of the measurement data CMD associated with the coordinates of the visualization section VS3 may be displayed in color C2, and a representative value of the measurement data CMD associated with the coordinates of the visualization section VS5 may be displayed in color C3.

For example, color C1 may indicate that the representative value of the visualization sections VS1, VS2, VS4, and VS6 is normal, color C2 may indicate that the representative value of the visualization section VS3 is excessive, and color C3 may indicate that the representative value of the visualization section VS3 is significantly excessive. Color C4 may indicate that the representative value is insufficient, and color C5 may indicate that the representative value is significantly insufficient.

In this manner, the roll map may display the position of the electrode in coordinates and visualized measurement data (e.g., electrode slurry loading amount data) for each position, whereby the efficiency of electrode production management may be improved using the roll map and the data included in the roll map.

FIG. 2B illustrates a patterned electrode sheet in which coated portions and uncoated portions are repeatedly arranged in the longitudinal direction to form patterns.

The patterned electrode sheet may be slit in the width direction with respect to an uncoated portion 1 between the coated portions 2 in the subsequent process. The slit coated portion 2 may be stacked with a separator and an electrode coated portion of a different polarity to form a stacked electrode assembly, or may be wound together with the separator and the electrode coated portion of the different polarity to form a jelly roll-shaped electrode assembly.

In particular, the patterned electrode used for a small battery may be slit in the longitudinal direction of the patterned electrode to form a plurality of electrode lanes L1 to L20 while being slit in the width direction.

Unlike a typical electrode in which the coated portions are formed consecutively in the longitudinal direction, the coated portion of the patterned electrode is formed intermittently. Therefore, a roll map method as shown in FIG. 2A, which indicates the longitudinal position of the electrode as length coordinates in succession, may not be suitable for the patterned electrode. For example, the uncoated portion of the patterned electrode has a loading amount as a measurement value of 0, and it does not significantly affect the actual battery performance, so that there is no need to display this part in detail by associating measurement data with coordinates. In addition, in the patterned electrode, the electrode assembly is made according to the length and width of the coated portion 2 included in the pattern. In other words, the electrode production performance is determined by the quantity of the coated portion 2 or the pattern including the coated portion 2. In this manner, the patterned electrode should be assigned position data based on the characteristics of the patterned electrode in which the electrode is produced and managed, and the coated portion and the uncoated portion are intermittently made based on the pattern. The present disclosure aims to describe a battery manufacturing method and battery manufacturing system that may generate monitoring data based on pattern indicator data, which may include position data suitable for such a patterned electrode.

### First Embodiment

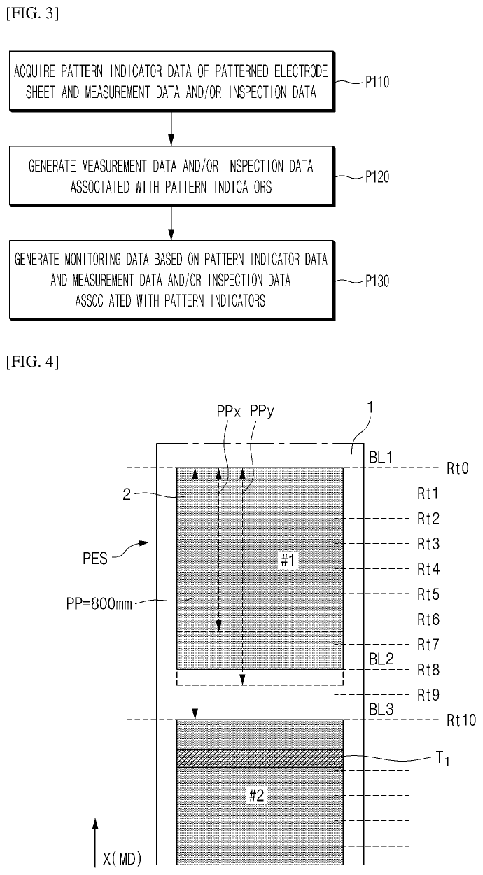

FIG. 3 is a flowchart illustrating a battery manufacturing method according to an exemplary embodiment of the present disclosure. FIG. 4 illustrates a roll map of a patterned electrode sheet in which loading amount measurement data is arranged over time according to an exemplary embodiment of the present disclosure.

The battery manufacturing method of the present disclosure includes, when a patterned electrode sheet moves in the longitudinal direction, acquiring pattern indicator data including pattern indicators intermittently indicating positions on the patterned electrode sheet, and measurement data and/or inspection data for the patterned electrode sheet (P110). A pattern indicator may be a number, character, symbol and/or code.

As described above, in processes (coating, roll pressing, slitting, etc.) for producing the patterned electrode, the patterned electrode sheet may be moved in the longitudinal direction. The patterned electrode sheet may be moved between an unwinder and a winder. In this case, a first electrode roll on which the patterned electrode sheet is wound may be loaded into the unwinder. The patterned electrode sheet unwound from the unwinder may be moved after being subjected to a predetermined treatment, and wound around the winder to form a second electrode roll. Alternatively, the patterned electrode sheet may be moved in the longitudinal direction by a conveyor or other driving means.

In this disclosure, one pattern may refer to one coated portion and one uncoated portion consecutively from the coated portion. When the pattern indicators are assigned by considering only the coated portion or the uncoated portion as the pattern, the overall state of the patterned electrode sheet may not be completely expressed. Referring to FIG. 2B, the uncoated portions are located on both sides of one coated portion. Therefore, one pattern may be obtained by including one coated portion and one uncoated portion at one side of the coated portion, or one coated portion and one uncoated portion at the other side of the coated portion. Pattern indicator data may be acquired by counting each pattern to increase or decrease the pattern number or identify differently using letters, characters, symbols, codes, or a combination of numbers and letters.

For example, the pattern indicator data may be pattern numbers assigned to each pattern. The pattern numbers may be counted by, for example, a pattern counter. Accordingly, the pattern indicator data may be acquired by the pattern counter. Each counted pattern number may represent a position on the moving patterned electrode sheet. Accordingly, the pattern counter may be a position measuring device that measures the position of the patterned electrode sheet. When recognizing the start and end of the pattern, the pattern counter may count the pattern number of one pattern. However, it should be understood that the pattern counter may count the pattern number associated with a plurality of patterns. The pattern counter intermittently counts the pattern numbers. In other words, the pattern counter may count the pattern number for one pattern or for a plurality of patterns. In this specification, the pattern counter that measures intermittent position values (pattern numbers) may be referred to as a first position measuring device. As will be described below, an encoder that measures consecutive position values (coordinate values) may be referred to as a second position measuring device.

The length of one pattern may vary depending on the type or model of the patterned electrode. The length of one pattern specified for a specific patterned electrode sheet may be referred to as a set pattern pitch. That is, a pattern pitch that is the sum of a set length of one coated portion and a set length of one uncoated portion may be referred to as a set pattern pitch.

When the length (pitch) of one pattern is different from the set pattern pitch, the corresponding pattern becomes a pattern of an abnormal pitch. According to an embodiment of the present disclosure, the battery manufacturing method may further include determining the pattern of the abnormal pitch by comparing the set pattern pitch with the length of each pattern.

The length of each pattern and/or the length of each of the coated portion and the uncoated portion included in the pattern may be derived by multiplying differences in boundary detection time points of the coated portion and the uncoated portion included in each pattern and the moving speed of the patterned electrode sheet.

The pattern counter may include a pitch sensor and a trigger board. The pitch sensor may measure the length of each pattern, that is, the pitch of each pattern.

According to an exemplary embodiment, the pitch sensor may be a photoelectric sensor or may include a photoelectric sensor. The photoelectric sensor includes a light emitting unit and a light receiving unit. When light emitted from the light emitting unit is blocked or reflected by an object to be detected, the amount of light reaching the light receiving unit is changed. The light receiving unit detects this change, converts the detected data into an electrical signal, and outputs the electrical signal. The amount of light emitted from the light emitting portion and reaching the light receiving portion with respect to the boundary lines between the coated portion 2 and the uncoated portion 1 on the patterned electrode is changed. Accordingly, the pattern counter equipped with the pitch sensor may determine the coated portion and uncoated portion on the patterned electrode. An optical fiber sensor may be used as the photoelectric sensor. The optical fiber sensor employs an optical fiber instead of the lens of the photoelectric sensor, and since the optical fiber, which is a detection unit, has no electrical part, it has the advantage of excellent environmental resistance such as noise resistance.

When the photoelectric sensor provided in the pitch sensor detects the boundary lines between the coated portion and the uncoated portion, the boundary detection time point may be also recorded at the same time. Accordingly, a distance between the boundary lines may be obtained by multiplying the differences (time) of the boundary detection time point of the coated portion and the uncoated portion included in each pattern and the moving speed of, for example, the patterned electrode sheet. The pitch sensor or the pattern counter may include a calculation unit for calculating the time and speed.

Referring to FIG. 4, a process of finding a pattern with an abnormal pitch using a pattern counter will now be described.

When the patterned electrode sheet travels in the longitudinal direction (traveling direction MD), the pattern counter may detect boundary lines BL1, BL2, and BL3 of the coated portion and the uncoated portion.

BL1 is the boundary line of the first coated portion 2 below the first uncoated portion 1 at the top of FIG. 4. BL2 is the boundary line between the first coated portion and the second uncoated portion below the first coated portion. BL3 is the boundary line between the second coated portion and the second uncoated portion below the second coated portion.

For example, the pattern counter may count the pattern numbers to increment the pattern number by 1 when BL1 and BL3 are detected for each pattern.

The pattern counter may obtain the length of the first coated portion by multiplying a difference (time) between a BL1 detection time point and a BL2 detection time point by the moving speed of the patterned electrode sheet.

The pattern counter may obtain the length of the second uncoated portion by multiplying the difference (time) between the BL2 detection time point and the BL3 detection time point by the moving speed of the patterned electrode sheet.

The pattern counter may obtain the length (pitch) of a first pattern #1 by multiplying the difference (time) between the BL1 detection time point and the BL3 detection time point by the moving speed of the patterned electrode sheet. In the same way, the pattern counter may obtain the length of a second pattern #2.

In addition, a pattern with an abnormal pitch (length) may be determined by comparing the length of the pattern with a set pattern pitch PP. In FIG. 4, PPx indicates a pattern with an abnormal pitch smaller than the set pattern pitch Pp. PPy indicates a pattern with an abnormal pitch greater than the set pattern pitch PP. For example, a pattern that has a large difference from the set pattern pitch may be determined as the abnormal pattern. The electrode portion of the abnormal pattern may be removed in the subsequent process.

The pitch sensor may transmit the length of the detected pattern to a trigger board. The trigger board may generate count information for each pattern based on the length of each pattern received from the pitch sensor. That is, the trigger board may increase the count value for each received length of the pattern. For example, the trigger board may increase a binary coded decimal (BCD) code by 1 whenever the count value for each length of the pattern increases. The trigger board may convert the count value for each length of the generated pattern into the BCD code form and transmit the converted result to the controller of each process or the server of the battery manufacturing system. For example, the pattern counter (trigger board) may count the pattern numbers in a way that the pattern number increases by 1 for each pattern (so-called ascending order). Alternatively, the pattern counter may count the pattern numbers in a way that the pattern number decreases by 1 for each pattern (so-called descending order). However, these are not only the count methods. It is understood that the pattern counter is able to indicate using pattern indicators so that the position of the pattern may be specified in any method. A pattern indicator may be numbers, letters, characters, symbols, codes, and/or a combination of numbers and letters.

Electrode specification data ESD may include model information, a recipe, and a pattern pitch of the electrode sheet. The electrode specification data ESD may include various details related to the number of lots processed in the current process, the number of lanes of the coated portion provided on the electrode sheet, the process condition including temperature, humidity, and pressure, the moving speed of the electrode sheet, discharge volume of coating die, pressure of pressing rolls, etc. The electrode specification data ESD may be stored in the controller or server of each process. The pattern counter may download information about the set pattern pitch from the controller or server and find the pattern of the abnormal pitch.

Measurement data and/or inspection data may be acquired for the patterned electrode sheet. The measurement data and/or inspection data may refer to data that may be obtained through measurement or inspection on the patterned electrodes. The measurement data and inspection data may be acquired by the measurement and inspecting devices that measure and inspect the electrodes.

The measurement data may include measurement results expressed in numerical values. For example, the measurement data may include dimensional data of the patterned electrode sheet PES such as thickness and width, data of a loading amount of coating material on the patterned electrode sheet PES, mismatching data between lanes of the coated portion on the upper surface of the patterned electrode sheet PES and lanes of the coated portion on the lower surface the patterned electrode sheet PES. As a non-limiting example, the measuring device may be either a web gauge or thickness measuring device made by Thermo Fisher Scientific Inc.

The inspection data may include determination and process events for the quality of the portions of the patterned electrode sheet PES. For example, the inspection data may include data on the appearance of the patterned electrode sheet PES collected by an image-based inspecting device such as a vision machine, data on the disconnection and seams of the patterned electrode sheet PES, data of the portion of the patterned electrode sheet PES on which sampling inspection was performed, data of a portion where the patterned electrode sheet PES is scheduled to be scraped, data of reference points indicating the position of the patterned electrode sheet PES, and defective data such as pinhole defects, crater defects, and line defects. The inspecting device may be any of a color sensor, a seam sensor, a reference point sensor, and a vision machine.

The pattern indicator data, measurement data, and inspection data may be time series data. The pattern indicator data may include the pattern indicators and time values matched to the pattern indicators, and the measurement data and/or inspection data may include measurement values and/or inspection values and time values matched to the measurement values and/or inspection values.

That is, the pattern indicators, measurement values, and inspection values may be arranged over time.

Referring to FIG. 3, the battery manufacturing method according to the present disclosure may include generating measurement data and/or inspection data associated with the pattern indicators by associating the pattern indicator data with the measurement data and/or inspection data (P120).

For example, the pattern indicators and the measurement values and/or inspection values may be associated with each other to correspond to the same time value.

Referring now to FIG. 4, the loading amounts Rt0 to Rt10 measured at measurement points t0 to t10 are displayed.

BL1 was detected at time point t0, BL2 was detected at time point t8, and BL3 was detected at time point t10 by the pattern counter. Therefore, the time values corresponding to the pattern of pattern number #1 are t0, t8, and t10. The loading amounts measured at the time values t0, t8, and t10 are Rt0, Rt8, and Rt10, and these loading amounts become measurement values associated with pattern number #1. More specifically, the loading amounts Rt0, Rt1, Rt2, Rt3, Rt4, Rt5, Rt6, Rt7, and Rt8 measured between time points t0 to t8 become measurement values associated with the coated portion between BL1 and BL2. In addition, the loading amounts Rt8, Rt9, and Rt10 measured between t8 and t10 become measurement values associated with the uncoated portion between BL2 and BL3.

In addition, the start and end points of a connection tape T1 located on the coated portion of pattern number #2 may be detected by the seam sensor. Seam measurement data includes a seam measurement signal and time values regarding the start and end points. In this case, the seam measurement data may be associated with the pattern of pattern number #2, which matches the same time value as the time value of the start point and end point of detecting the connection tape T1.

As described above, the pattern counter may obtain the length of each pattern and the length of each of the coated portion and the uncoated portion included in each pattern by multiplying differences in the detection time point of the boundary line between the coated portion and the uncoated portion and the moving speed of the patterned electrode sheet. According to the same principle, when an appropriate calculation tool is available, it is also possible to obtain the length of the coating or uncoated portion corresponding to each measurement section by multiplying the differences (time) of measurement time points of each measurement value by the moving speed of the patterned electrode sheet. The calculation tool may be provided in, for example, the pattern counter, the process controller, the measuring device, or the inspecting device.

The association of the pattern indicator with the measurement data and/or inspection data may be performed in the controller of the processing process in which the patterned electrode sheet is processed. In this case, the measurement data and inspection data acquired from the measuring device and/or inspecting device may be transmitted to the controller, and the pattern indicator data acquired from the pattern counter may also be transmitted to the controller. The controller may compare the time values of the measurement data and inspection data with the time values included in the pattern indicator data to associate the pattern indicators with the measurement data and inspection data.

Alternatively, the association of the pattern indicator with the measurement data and/or inspection data may be performed in the measuring device and/or the inspecting device. In this case, the pattern indicator data acquired from the pattern counter may be transmitted to the measuring device and/or inspecting device directly or through the controller. The measuring device and/or inspecting device may compare the acquired time values of the measurement data and inspection data with the time values included in the pattern indicator data to associate the pattern indicators with the measurement data and inspection data.

Referring to FIG. 3, the battery manufacturing method according to the present disclosure may include generating monitoring data for manufacturing a battery based on the pattern indicator and the measurement data and/or inspection data associated with the pattern indicators (P130).

As described above, by assigning the pattern indicators to the patterned electrode, the positions and indicator of the patterns of the patterned electrode may be easily specified. As a result, the production performance of the patterned electrode may be easily determined. In addition, by associating the measurement data and/or inspection data acquired for the patterned electrode with the pattern indicator, it may be possible to easily determine the state of each pattern, whether the electrode is broken, or whether the electrode is defective. The roll map is one of the monitoring data in the electrode manufacturing process. As shown in FIG. 4, the roll map for the patterned electrode may include pattern indicator data including pattern indicators and measurement data or inspection data associated with the pattern indicators. The measurement data and/or inspection data are a type of process event data that occurs in each process. The roll map may be cumulatively generated for work pieces, parts, semi-finished products, and products of unit processes, thereby enabling tracking of process history for shipped products (e.g., battery cells, battery modules, or battery packs). For instance, the shipped products may include cell IDs that may be used to enable tracking of the process history should a need arise.

As shown in FIG. 4, a plurality of measurement values may be assigned for one pattern. In FIG. 4, 10 measurement values are associated per pattern, but depending on the type of measuring instrument or inspecting instrument, a large number of measurement values and/or inspection values may be associated. In this way, when the size of measurement data and/or inspection data increases, a load is applied to the server system for generating the monitoring data. This may slow down data processing speed. The measurement data and/or inspection data may be compressed to reduce data size and increase a data processing speed.

For example, a processing unit provided in the measuring instrument and/or inspecting instrument may be configured to generate the compressed measurement data and/or inspection data on the basis of the pattern indicator data and the measurement data and/or inspection data. The compressed measurement data and/or inspection data has a smaller size than the measurement data and/or inspection data associated with the pattern indicator data. The resources of the server for generating the monitoring data may be reduced due to the compressed measurement data and/or inspection data.

The compressed measurement data and/or inspection data may include a representative value of the measurement values and/or inspection values of the measurement data and/or inspection data, and pattern indicator data for starting and ending points of a portion of the electrode sheet in which the measurement data and/or inspection data are collected. The compressed measurement data may further include a time stamp indicating the collection date and time of the measurement data and/or inspection data for each pattern or plurality of patterns, a measuring instrument and/or inspecting instrument ID, and a facility ID.

For example, the processing unit of the measuring instrument and/or inspecting instrument may calculate a representative value of the measurement data and/or inspection data for each pattern of the electrode sheet. The representative value may include at least one of an average, a standard deviation, a median, a maximum value, and a minimum value of the measurement data and/or inspection data of each pattern.

For example, when loading amount data corresponding to pattern number #1 has 10 measurement values corresponding to one scanning of the loading amount measuring instrument, the compressed measurement data may include a single representative value calculated based on the 10 measurement values. Accordingly, the size of the compressed measurement data may be smaller than the size of the measurement data associated with the pattern indicator data. In this case, the representative value may indicate a plurality of patterns in addition to indicating one pattern. That is, a single representative value may be acquired by grouping the plurality of patterns into groups and compressing the measurement data and/or inspection data acquired for each group. In this case, among the measurement values included in each pattern, the measurement values less than a certain value may be regarded as, for example, values measured in the uncoated portion of the corresponding pattern and excluded when calculating the representative value. That is, the representative value may be calculated from the measurement values included in each pattern that are greater than or equal to the certain value.

The pattern indicators of the starting and ending points of each pattern of the electrode sheet in which the measurement data and/or inspection data are collected may be determined based on the pattern indicator data. Alternatively, the pattern indicator of the starting and ending points of a portion of the electrode sheet corresponding to the plurality of patterns grouped by group may be determined. The pattern indicators of the starting and ending points of the compressed measurement data and/or inspection data may be substantially the same as the pattern indicators of the starting and ending points of the measurement data and/or inspection data associated with the pattern indicator data.

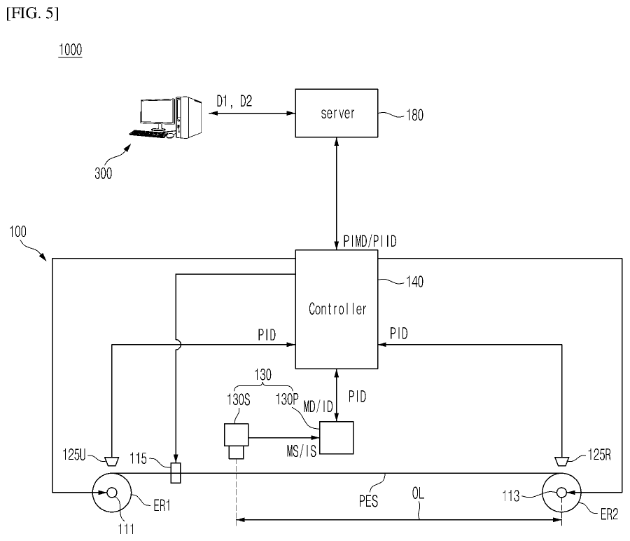

FIG. 5 illustrates a battery manufacturing system according to another exemplary embodiment of the present disclosure.

A battery manufacturing system 1000 may include a battery manufacturing apparatus 100, a server 180, and a user device 300.

The battery manufacturing system 1000 may include an unwinder 111, a rewinder 113, a processing mechanism 115, first position measuring devices 125R and 125U, a measuring device and/or inspecting device 130, and a controller 140.

The unwinder 111 may be configured to unwind a patterned electrode sheet PES from electrode roll ER1. The rewinder 113 may be configured to wind the patterned electrode sheet PES into patterned electrode roll ER2. Accordingly, the patterned electrode sheet PES may move between the unwinder 111 and the rewinder 113.

A process for manufacturing a battery (e.g., an electrode process) may be performed on the patterned electrode sheet PES.

The electrode sheet or patterned electrode sheet PES may be processed by the processing mechanism 115. For example, the processing mechanism 115 may include a coater, and an electrode slurry may be applied on the electrode sheet to form a patterned electrode sheet PES. As another example, the processing mechanism 115 may include a pressing roll, and a roll pressing process may be performed on the patterned electrode sheet PES coated with the electrode slurry. As another example, the processing mechanism 115 may include a splicing die and a scrap pot, and portions of the patterned electrode sheet PES may be scrapped. As another example, the processing mechanism may include a slitting knife and the patterned electrode sheet PES may be separated into a plurality of electrode sheets.

In this embodiment, the pattern indicators being pattern numbers will be used as an example. The first position measuring devices 125R and 125U may be pattern counters that count the pattern numbers on the patterned electrode. The pattern number intermittently indicates the position on the patterned electrode sheet PES moving between the unwinder and the rewinder.

The first position measuring device 125U installed on the unwinder side may be configured to sense the amount of the electrode sheet or patterned electrode sheet PES unwound from electrode roll ER1 by the unwinder 1111. The controller 140 may be configured to collect pattern indicator data PID generated by the first position measuring device 125U.

The first position measuring device 125R installed on the rewinder side may be configured to sense the amount of the patterned electrode sheet PES wound around patterned electrode roll ER2 by the rewinder 113. The controller 140 may be configured to collect pattern indicator data PID generated by the first position measuring device 125R. The pattern indicator data PID may indicate the production result of the battery manufacturing apparatus 100. Hereinafter, the technical sprit of the present disclosure will be described focusing on an embodiment in which the controller 140 collects pattern indicator data PID generated by the first position measuring device 125R.

As a non-limiting example, the controller 140 is a process controller that may control the processing (coating, roll pressing, slitting, etc.), and may be a programmable logic controller (PLC). The controller 140 may include a power supply, a CPU, an input interface, an output interface, a communication interface, and memory devices. The communication interface may be configured to transmit and receive data between the controller 140 and the first position measuring devices 125U and 125R, and between the measuring device and/or inspecting device 130 and the server 180.

The measuring device may be configured to collect measurement data MD by measuring the patterned electrode sheet PES. The inspecting device may be configured to collect inspection data ID by inspecting the patterned electrode sheet PES. There may be one or more measuring devices or inspecting devices. In this embodiment, for convenience of explanation, the measuring device and/or inspecting device are combined and denoted by one reference numeral 130.

The measuring device and/or inspecting device may include a sensing unit 130S and a processing unit 130P. The sensing unit 130S may be configured to sense a physical quantity of an electrode sheet ES to generate a measurement signal MS or an inspection signal IS. For example, the sensing unit 131S may include a time delay and integration (TDI) camera, a complementary metal oxide semiconductor (CMOS) image sensor, and a time of flight (TOF) sensor.

The processing unit 130P may be configured to receive the measurement signal MS or the inspection signal IS sensed by the sensing unit 130S to collect the measurement data MD or the inspection data ID. The processing unit 130P may be connected to the sensing unit 130S in a wired or wireless manner.

The controller 140 may collect the measurement data and/or inspection data MD/ID generated by the measuring device and/or inspecting device 130. In addition, the controller 140 may be configured to control the operations of the unwinder 111, the rewinder 113, and the processing mechanism 115. Signals for operating and stopping the unwinder 111, the rewinder 113, and the processing mechanism 115 may be generated based on electrode specification data ESD, and additional inspection signals and measurement signals.

Pattern indicators of the pattern indicator data PID may be associated with the measurement data and/or inspection data MD/ID. For example, the pattern indicators collected based on a specific time value may be associated with measurement data and/or inspection data MD/ID that matches the same time value. The processing unit 130P of the measuring device and/or inspecting device may receive pattern indicator data PID from the first position measuring devices 125U and 125R and associate the pattern indicator with the measurement data and/or inspection data. Alternatively, the pattern indicator data and the measurement data and/or inspection data may be transmitted to the controller 140 so that the pattern indicator may be associated with the measurement data and/or inspection data in the controller.

According to an exemplary embodiment, the measuring device and/or inspecting device 130 or the controller 140 may correct the pattern number of the pattern indicator data PID based on an offset length OL.

Since the position of the measuring device and/or inspecting device and the position of the first position measuring device are different, the portion of the patterned electrode sheet PES that is measured and/or inspected at the same time point and the portion of the patterned electrode sheet PES that is a target of the pattern number detected by the first position measuring device may be different. Therefore, the pattern number may be corrected by adding or subtracting the number of pattern numbers corresponding to the offset length to or from the pattern numbers of the pattern indicator data PID collected at the same time as the measurement data and/or inspection data, and the measurement data and/or inspection data associated with the corrected pattern numbers may be obtained by associating the corrected pattern number with the measurement data and/or inspection data. Such correction of the pattern number of the pattern indicator data PID may be performed in the processing unit 130P or controller 140 of the measuring device and/or inspecting device.

The measurement data and/or inspection data associated with the pattern indicator PIMD/PIID generated in the processing unit 130P may be transmitted to the server 180 directly or through the controller 140. Alternatively, the measurement data and/or inspection data associated with the pattern indicator PIMD/PIID generated in the controller 140 may be transmitted to the server 180.

The server 180 may generate monitoring data for manufacturing a battery based on the pattern indicator data PID and measurement data and/or inspection data associated with the pattern indicator PIMD/PIID. The server 180 performs various tasks for managing battery production in addition to generation of a roll map. For example, a battery cell may include a cell ID provided on an electrode assembly or case. For example, the cell ID may be marked on the electrode assembly or the case. The cell ID may include lot number and coordinate information of electrodes and separator included in the battery cell. The cell ID may be associated with the roll map of the electrodes and separator included in the battery cell. Accordingly, when an event such as a quality issue occurs in the battery cell that has already been shipped, the history of collective data in the manufacturing the battery cell may be retrieved using the cell ID.

The user device 300 may display a visualized roll map VRM as shown in FIG. 4. The user device 300 may be any device for communicating with the server 180, such as a workstation computer, a notebook computer, a laptop computer, a desktop computer, a tablet computer, a mobile device such as a smartphone, or a wearable device. The user device 300 may be configured to generate a request for loading the roll map. The server 180 may be configured to transmit various types of data D1 and D2 of the roll map to the user device.

### Second Embodiment

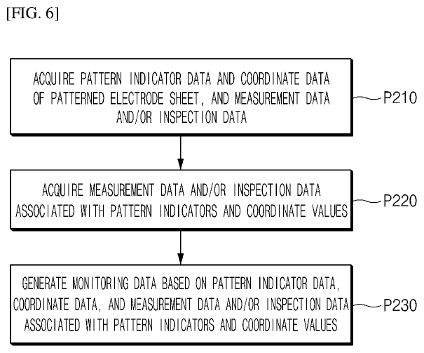

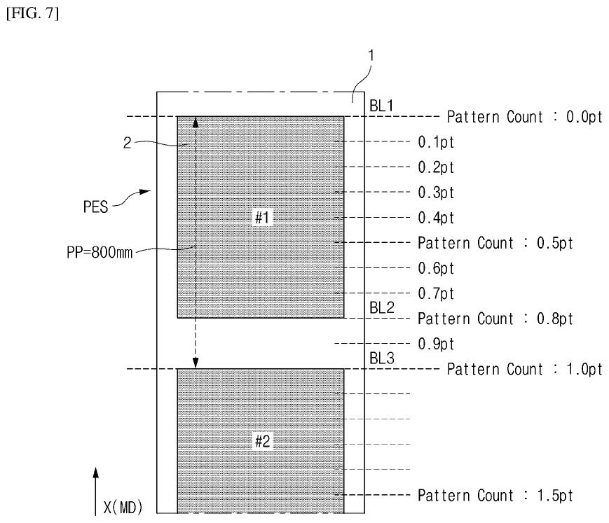

FIG. 6 is a flowchart illustrating a battery manufacturing method according to another exemplary embodiment of the present disclosure. FIG. 7 illustrates a roll map of a patterned electrode sheet on which pattern indicators and sub-pattern indicators are marked according to an exemplary embodiment of the present disclosure.

The battery manufacturing method according to the present disclosure may include, when the patterned electrode sheet moves in the longitudinal direction, acquiring pattern indicator data including pattern indicators intermittently indicating positions on the patterned electrode sheet, coordinate data including coordinate values indicating the longitudinal positions of the patterned electrode sheet in succession, and measurement data and/or inspection data for the patterned electrode sheet (P210).

A method was previously described that calculates, using a calculation tool, the length (pitch) of the pattern or the length of a section where the measurement data and/or inspection data is acquired, using the moving speed or time difference of the patterned electrode sheet. This method may require that the moving speed of the patterned electrode sheet be kept fairly constant, since if the moving speed is not always constant, there may be cases where a time point at which specific data is measured on the patterned electrode sheet and the position of the patterned electrode sheet at that time point may not correspond to each other accurately. For instance, the moving speed of the patterned electrode sheet may change depending on the standard of the patterned electrode sheet, a type of a model, a type of processing process, and driving mechanism of a processing device. A method will be described below that does not indirectly obtain the position or distance of the patterned electrode sheet using the moving speed and time difference, which may reduce the amount of data processing.

In the embodiment of FIG. 6, the pattern indicator data and the coordinate data may be used together to display the longitudinal position of the patterned electrode sheet. For example, the pattern indicator data including the pattern indicators intermittently indicating the positions on the patterned electrode sheet may be acquired as main position data, and at the same time, the coordinate data including the coordinate values indicating the longitudinal positions in succession may be further acquired. The coordinate values and the difference between the coordinate values directly indicate the position of the patterned electrode sheet or a distance of a specific section. Accordingly, by acquiring the coordinate data, it may be possible to acquire position information about the patterned electrode sheet without having influence by a change in the moving speed of the electrode sheet. Also, additional calculations performed to obtain the position or distance of the patterned electrode sheet using the moving speed and time difference may not be required. By associating this coordinate data with the pattern indicator data, with the measurement data and/or inspection data, or with the measurement data and/or inspection data associated with the pattern indicator, state information about the patterned electrode sheet may be obtained more quickly.

A first position measuring device (pattern counter) may be used to acquire the pattern indicator data. A second position measuring device may be additionally used to acquire the coordinate data. The second position measuring device may be a rotary encoder that may represent a position signal of the patterned electrode sheet moving according to the rotation amount of the unwinder or rewinder as an encoder value. Alternatively, the second position measuring device may be a linear encoder that represents a position signal corresponding to the movement displacement of the patterned electrode sheet as an encoder value. The encoders may be configured in a contact or non-contact manner with the electrode sheet. The second position measuring device may be equipped with a predetermined calculation unit to convert the encoder value into a coordinate value. Alternatively, the controller may receive the encoder value and convert the encoder value into the coordinate value through a predetermined calculation. Considering the load exerted on the process controller, it may be desirable that the encoder directly convert the encoder value into the coordinate value.

By comparing a set pattern pitch and coordinate data, sub-pattern indicators obtained by further subdividing the pattern indicators may be obtained. For example, the pattern indicators and sub-pattern indicators may be pattern numbers and sub-pattern numbers, respectively, which will be used in FIG. 7, as an example.

Referring to FIG. 7, the patterned electrode sheet PES is moving in the longitudinal direction X, which is the traveling direction MD.

For example, the first position measuring device, which is a pattern counter, may detect the boundary lines BL1, BL2, and BL3 of the coated portions 2 and the uncoated portions 1 as shown in FIG. 7. For example, the second position measuring device, which is a rotary encoder, may indicate the longitudinal position of each pattern #1 or #2 as a coordinate value based on the encoder value. In this case, when the set pattern pitch PP is 800 mm, the set pattern pitch may be divided into 10 equal parts and the pattern number may be displayed in decimal units. For example, when the patterned electrode sheet moves by 80 mm and the controller receives the coordinate value corresponding to 80 mm, the controller may count the pattern number of 0.1 Pt at the position corresponding to this coordinate value. Until the patterned electrode sheet moves by 800 mm and the first position measuring device detects the boundary BL3 of the coated portion of pattern number #2, the controller may count the sub-pattern numbers from 0.1 Pt to 1.0 Pt to correspond to the coordinate value of each point. As described above, by comparing the set pattern pitch and the coordinate data to obtain the sub-pattern numbers, the pattern numbers may be displayed in more detail. Accordingly, the pattern of the abnormal pitch may be more easily determined.

Even in FIG. 7, the pattern of the abnormal pitch may be determined by comparing the set pattern pitch and the length of each pattern.

In this case, the length of each pattern and/or the length of each of the coated portion and the uncoated portion included in the pattern may be determined based on a difference in coordinate values between the start and end points of each pattern, a difference in coordinate values between the start and end points of the coated portion, and a difference in coordinate values of the start and end points of the uncoated portion. In this case, since the coordinate value directly indicating the position and distance is compared with the pattern pitch, the length (pitch) of the pattern may be intuitively obtained without a separate calculation for obtaining the distance (length) as in the first embodiment. Therefore, it may be possible to more quickly identify the pattern with an excessive or insufficient pitch.

Referring to FIG. 6, the battery manufacturing method according to the present disclosure may include generating measurement data and/or inspection data associated with the pattern indicators and the coordinate values by associating the pattern indicator data, the coordinate data, and the measurement data and/or inspection data (P220).

As described with respect to the first embodiment, the pattern indicators and measurement values of the measurement data and/or inspection values of the inspection data may be associated with each other to correspond to the same time value. In the second embodiment, in addition to this, the coordinate values of the coordinate data may be associated with one or more of the following: i) pattern indicators; ii) measurement values and/or inspection values; and iii) pattern indicators and time values matched to the measurement values and/or inspection values.

That is, since the coordinate values are associated with the pattern indicators, the coordinate data and the pattern indicator data are associated with each other.

In addition, since the coordinate values correspond to the measurement values and/or inspection values, the coordinate data and the measurement data and/or inspection data are associated with each other.

From this, the pattern indicator data may be associated with the measurement data and/or inspection data based on the coordinate values (coordinate data), and may even exclude time values (time series data).

Also, the coordinate values may be associated with the pattern indicators and the time values matched to the measurement values and/or inspection values. In this case, the pattern indicator data is associated with the measurement data and/or inspection data based on the time values (time series data) and the coordinate values (coordinate data).

The battery manufacturing method according to the present disclosure includes generating monitoring data for manufacturing a battery based on the pattern indicator data, coordinate data, and the measurement data and/or inspection data associated with the pattern indicators and the coordinate values (P230).

As the monitoring data, the roll map including the coordinate data may be provided. As shown in FIG. 7 described below, the roll map regarding the patterned electrode may include the pattern indicator data including the pattern indicators, the coordinate data including the coordinate values, and measurement data or inspection data associated with the pattern indicators and the coordinate values. Using this roll map, the length, state, and characteristics of the pattern on the patterned electrode sheet may be determined more comprehensively and intuitively.

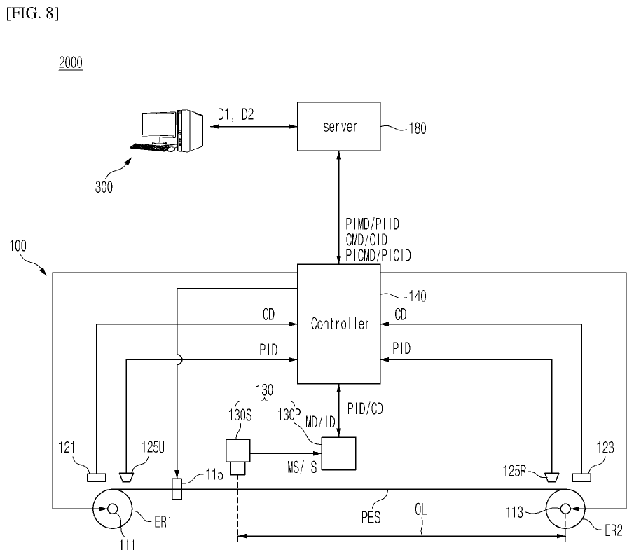

FIG. 8 illustrates a battery manufacturing system according to yet another exemplary embodiment of the present disclosure.

The battery manufacturing system 2000 may include a battery manufacturing apparatus 100, a server 180, and a user device 300.

The battery manufacturing apparatus 100 may include an unwinder 111, a rewinder 113, a processing mechanism 115, first position measuring devices 125R and 125U, second position measuring devices 121 and 123, a measuring device and/or inspecting device 130, and a controller 140.

This embodiment differs from the first embodiment in that second position measuring devices 121 and 123 are added. Coordinate data may be acquired by the second position measuring devices 121 and 123, and a difference between the first and second embodiments is that the coordinate data is associated with other data. Repeated descriptions of the same points between the second embodiment and the first embodiment may be omitted.

For example, pattern indicator data PID that intermittently indicates the position on the patterned electrode sheet is acquired by the first position measuring devices 125R and 125U, which are pattern counters. The controller 140 may collect, for example, pattern indicator data PID generated by the first position measuring device 125U installed in the rewinder 113.

The second position measuring device is, for example, a rotary encoder.

The first rotary encoder 121 of the second position measuring device may be configured to sense the amount of a patterned electrode sheet PES unwounded from electrode roll ER1 by the unwinder 111. Accordingly, the first rotary encoder 121 may be configured to generate an unwound amount signal indicating the unwound amount of the patterned electrode sheet PES. The first rotary encoder 121 may directly acquire input amount data (coordinate data) by converting the unwound amount signal. Alternatively, the first rotary encoder 121 may transmit the unwound amount signal to the controller 140, and the controller 140 may convert the signal to collect the input amount data. The input amount data is the amount of material (i.e., electrode roll ER1) input into the battery manufacturing apparatus 100 to manufacture a battery, and is coordinate data CD.

The second rotary encoder 123 may be configured to sense the amount of the patterned electrode sheet PES wound around electrode roll ER2 by the rewinder 113. Accordingly, the second rotary encoder 123 may be configured to generate a winding amount signal indicating the winding amount of the electrode sheet ES. The second rotary encoder 123 may convert the winding amount signal to directly acquire consumption amount data (coordinate data). Alternatively, the second rotary encoder 123 may transmit the winding amount signal to the controller 140, and the controller 140 may convert the transmitted signal to collect the consumption amount data. The consumption amount data may indicate the production performance of the battery manufacturing apparatus 100.

The controller 140 may associate the pattern indicator data PID with the coordinate data CD.

The measuring device and inspecting device 130 may measure and/or inspect the patterned electrode sheet PES to collect measurement data MD and/or inspection data ID.

The processing unit 130P of the measuring device and/or inspecting device may be configured to receive a measurement signal MS or an inspection signal IS sensed by the sensing unit 130S to collect the measurement data MD or the inspection data ID.

The controller 140 may collect the measurement data and/or inspection data MD/ID generated by the measuring device and/or inspecting device 130.

The pattern indicators of the pattern indicator data PID may be associated with the measurement data and/or inspection data MD/ID. For example, the pattern indicators collected based on a specific time value may be associated with the measurement data and/or inspection data MD/ID matching the same time value. Alternatively, coordinate values of the coordinate data may be associated with the measurement data and/or inspection data or the measurement data and/or inspection data associated with the pattern indicator. The processing unit 130P of the measuring device and/or inspecting device may receive the pattern indicator data PID from the first position measuring devices 125U and 125R and associate the pattern indicator with the measurement data and/or inspection data. Alternatively, the pattern indicator data, measurement data, and/or inspection data may be transmitted to the controller 140, and the pattern indicator may be associated with the measurement data and/or inspection data in the controller. In addition, the processing unit 130P of the measuring device and/or inspecting device may receive the coordinate data CD from the second position measuring devices 121 and 123 and associate the pattern indicator with the measurement data and/or inspection data. Alternatively, the coordinate data and the measurement data and/or inspection data may be transmitted to the controller 140 so that the coordinate data may be associated with the measurement data and/or inspection data in the controller.

In the controller, coordinate data and pattern indicator data may be associated with measurement data and/or inspection data.

According to an exemplary embodiment, the measuring device and/or inspecting device 130 or the controller 140 may correct the pattern indicator data PID and the coordinate data CD based on an offset length OL.

The principle of correcting the coordinate data based on the offset length OL may be the same as the principle of correcting the pattern indicator data described above. That is, since the position of the measuring device and/or inspecting device may be different from the position of the second position measuring device, the portion of the patterned electrode sheet PES that is measured and/or inspected at the same time point may be different from the portion of the patterned electrode sheet PES that is detected by the second position measuring device. Accordingly, the above-described coordinate data may be corrected by subtracting or adding the offset length from or to the coordinate data of the second position measuring device collected at the same time as the measurement data and/or inspection data.

The measurement data and/or inspection data associated with the coordinate data CMD/CND generated in the processing unit 130P, the measurement data and/or inspection data associated with the pattern indicator PIMD/PIID, and the measurement data and/or inspection data associated with the pattern indicator and coordinate value PICMD/PICID may be transmitted to the server 180 directly or through the controller 140. Alternatively, the measurement data and/or inspection data associated with the coordinate data CMD/CND generated in the controller 140, the measurement data and/or inspection data associated with the pattern indicator PIMD/PIID, and the measurement data and/or inspection data associated with the pattern indicator and the coordinate value PICMD/PICID may be transmitted to the server 180.

The server 180 may generate a roll map including the measurement data and/or inspection data associated with the coordinate data CMD/CND generated in the controller 140, the measurement data and/or inspection data associated with the pattern indicator PIMD/PIID, and the measurement data and/or inspection data associated with the pattern indicator and the coordinate value PICMD/PICID. The roll map of this embodiment mainly indicates the measurement data and/or inspection data of the patterned electrode sheet based on the pattern indicator data and auxiliary indicates the measurement data and/or inspection data based on the coordinate data, thereby significantly improving the visibility of information about the pattern of the patterned electrode sheet.

### Third Embodiment

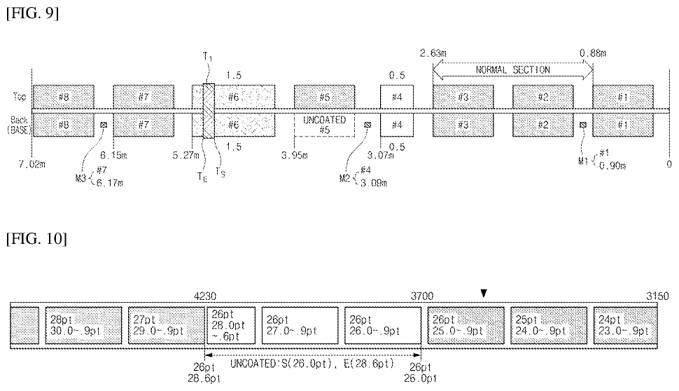

FIG. 9 illustrates pattern indicator data and coordinate data marked on a patterned electrode sheet with patterned electrodes formed on the upper and lower surfaces thereof according to an exemplary embodiment of the present disclosure.

FIG. 9 illustrates a roll map of a double-sided electrode obtained by simulating the coating state of an actual patterned electrode sheet. The portions other than the coated portions on the patterned electrode sheet are the uncoated portions.

In this example, a first uncoated portion on the right side of FIG. 9 and a coated portion adjacent thereto may be combined and counted as pattern number #1. Alternatively, a first coated portion on the right side of FIG. 9 and an uncoated portion on the left side adjacent to the first coated portion may be combined and counted as pattern number #1. A first position measuring device sequentially detected the boundary line of the uncoated portion and the coated portion, detected patterns of pattern numbers #1 to #8, and acquired pattern indicator data. The roll map also displays coordinate data (displayed in m units) acquired by a second position measuring device. To avoid data overload, the coordinate data may be displayed on main portions of the roll map.

As shown in FIG. 9, a roll map may be generated not only for a single-sided electrode with a coated portion formed on only one side of the patterned electrode sheet, but also for a double-sided electrode with a coated portion formed on both sides of the patterned electrode sheet. To prevent excessive increase of roll map data, main event information may be collected and transmitted to the server. The server may generate the roll map for the double-sided electrode based on this. When performance management is performed considering both the upper and lower surface patterns, the amount of data to be considered increases, so that performance management may be performed based on either pattern of the upper or lower surface. In this embodiment, the pattern result may be managed based on the pattern of the lower surface pattern.

When the set pattern pitch is set to 878 mm, a pattern of an abnormal pitch may be displayed by comparing the pattern indicator data by the first position measuring device and the set pattern pitch based on the coordinate data by the second position measuring device. FIG. 9 shows a normal section coated according to the set pattern pitch. However, with respect to the lower surface pattern, a pattern with an insufficient length is measured and displayed at the position of pattern number #4, an uncoated section is measured and displayed at the position of pattern number #5, and a pattern with an excessive length is measured and displayed at the position of pattern number #6. For example, a pattern less than 0.5 times the set pattern pitch may be considered as a defective pattern. Alternatively, a pattern more than 1.5 times the set pattern pitch may be considered as a defective pattern.

When there is the uncoated section not included in the pattern between neighboring patterns, the pattern indicator may be assigned to the uncoated section by the number of patterns obtained by dividing the length of the uncoated section by the set pattern pitch. In FIG. 9, pattern number #5 was assigned to the uncoated section between the patterns #4 and #6. When the pattern indicator is not assigned to the uncoated section, there is a gap in the roll map information and the state of the patterned electrode sheet may not be completely expressed. Therefore, the roll map should include information about the uncoated section not included in the pattern, along with information about the pattern with the abnormal pitch that is different from the set pattern pitch. The information about the uncoated section is information about pattern indicators assigned to the uncoated section by the number of patterns obtained by dividing the uncoated section by the set pattern pitch.

In this example, information regarding reference points and seams is also included.

Reference points M1, M2, and M3 are marked on the patterned electrode sheet at predetermined intervals. In the roll map, the actual position of the reference point may be measured and the position and reference point interval may be displayed. When the interval between the reference points is changed from a set reference point position, changes in the electrode length that occur during the process or before and after the process may be identified. The display of a connection tape, which is a seam, may mean that the electrode was broken for some reason and was connected by the connection tape T1. The position of the connection tape T1 may be indicated by acquiring coordinate values or pattern indicator data regarding the start point Ts and end point Te of the connection tape. From this information, it may be possible to more accurately identify the history of changes in the state of the actual patterned electrode sheet that was subjected to multiple processes.

In FIG. 9, three reference points M1, M2, and M3 are displayed, and the pattern indicator and coordinate value for each reference point are shown. The reference point may be measured by a reference point measuring device, and the seam may be measured by a seam sensor.

FIG. 10 illustrates a roll map in which pattern indicator data and coordinate data are marked in a coated section and an uncoated section according to an exemplary embodiment of the present disclosure. For example, the pattern indicators and sub-pattern indicators may be pattern numbers and sub-pattern numbers, respectively, which will be used in FIG. 10, as an example.

In FIG. 10, pattern numbers are displayed in sub-pattern number units.

In addition, coordinate values are displayed at main points.

In the roll map of FIG. 10, there is an uncoated section, and sub-pattern numbers are displayed even for the uncoated section in comparison with the set pattern pitch. The uncoated section includes an uncoated portion corresponding to two set pattern pitches and an uncoated portion corresponding to 0.6 times (0.6 Pt) the set pattern pitch.

Meanwhile, only information on performance excluding the uncoated section may be collected and transmitted to the process controller. The controller is process equipment that controls the process, processes the actual performance produced by the actual electrode, and records the performance. Among the pattern numbers in FIG. 10, those that are not sub-pattern numbers (numbers not expressed in decimal units: for example, 24 pt) are pattern numbers indicating performance. In the uncoated section, the pattern number remained unchanged as 26 pt, and became 27 pt at the end of the uncoated section, so that the pattern number was increased by 1.

In this manner, according to the present disclosure, by using the above-described battery manufacturing system, pattern indicator data and coordinate data may be freely displayed, and further, pattern indicators that are counted as performance and pattern indicators that are not performance may be displayed separately.

Therefore, monitoring data and roll map data that match the state of the actual patterned electrode may be generated, thereby significantly improving data match.

The server, controller, device, unit, etc., disclosed in connection with various embodiments and the various elements therein comprised, which enable the implementation of methods and processes in accordance with the present disclosure, may be implemented by one or more processors having circuitry, such as one or more microprocessors executing software or firmware, and/or one or more application specific integrated circuits (ASICs), and/or a combination of ASICs, discrete electronic components (e.g., transistors), and microprocessors. In some embodiments, components shown as separate may be replaced by a single component. In addition, some of the components displayed may be additional, or may be replaced by other components.

In various embodiments, one or more memories may store a set of instructions that may be executed to cause one or more processors to perform any one or more of the methods or processes based on functionality disclosed in the present disclosure. The one or more memories may communicate via one or more electrical wires or buses or wirelessly. The one or more memories may be a static memory, or a dynamic memory. The one or more memories may include, but not limited to computer readable storage media such as various types of volatile and non-volatile storage media, including but not limited to random access memory, read-only memory, programmable read-only memory, electrically programmable read-only memory, electrically erasable read-only memory, flash memory, and the like. In one implementation, the one or more memories may include a cache or random-access memory for one or more processors. The one or more memories may be a cache memory of one or more processors, the system memory, or other memory. Processing strategies may include multiprocessing, multitasking, and the like. The computer readable storage media described in connection with the one or more memories in accordance with the various embodiments may be non-transitory, and may be tangible.

The present disclosure has been described above in more detail through the drawings and examples. However, since the embodiments described in this specification and configurations illustrated in drawings are only exemplary embodiments and do not represent the overall technological scope of the present disclosure, it is understood that the present disclosure covers various equivalents and modifications that are substitutable at the time of filing of this application.

What is claimed is:

1. A method of manufacturing a battery, comprising:
generating pattern indicator data that includes representing a plurality of positions at a patterned electrode sheet in which coated portions and uncoated portions are repeatedly arranged, and a coated portion and an uncoated portion adjacent to the coated portion constituting a pattern, wherein a position of the plurality of positions being a position of at least one coated portion and an adjacent uncoated portion at the patterned electrode sheet;
generating measurement data and/or inspection data for the patterned electrode sheet;
associating the generated measurement data and/or inspection data with the pattern indicator data; and
generating monitoring data for manufacturing the battery based on the associated measurement data and/or inspection data and the pattern indicator data.

2. The method of claim 1, wherein the pattern indicator data includes pattern indicators and time values matched to the pattern indicators,
the measurement data and/or inspection data includes measurement values and/or inspection values, and time values matched to the measurement values and/or inspection values, and
the pattern indicators and the measurement values and/or inspection values are associated with each other by corresponding to the same time value.

3. The method of claim 1, wherein the pattern indicator data includes pattern indicators, the method further comprises matching the pattern indicators with the positions of the plurality of positions at the patterned electrode sheet, wherein a pattern indicator is acquired by counting a position, and a count increases or decreases with the pattern indicator.

4. The method of claim 1, further comprises determining whether a pattern has an abnormal pitch by comparing a length of the pattern with a set pattern pitch.

5. The method of claim 4, further comprises deriving the length of the pattern by multiplying a difference between a boundary detection time point of a beginning of a coated portion and a boundary detection time point of an end of an uncoated portion included in the pattern with a moving speed of the patterned electrode sheet.

6. The method of claim 1, further comprises deriving a length of the coated portion included in the pattern by multiplying a difference between a boundary detection time point of a beginning of the coated portion and a boundary detection time point of an end of the coated portion with a moving speed of the patterned electrode sheet.

7. The method of claim 2, further comprises acquiring coordinate data including coordinate values indicating positions at the patterned electrode sheet,
wherein the coordinate values are associated with one or more of the following:
iii) the pattern indicators;
ii) the measurement values and/or inspection values; and
iii) the time values matched to the pattern indicators and the measurement values and/or inspection values.

8. The method of claim 6, further comprises obtaining sub-pattern indicators by comparing the coordinate data with a set pattern pitch.

9. The method of claim 6, further comprises determining whether the pattern has an abnormal pitch by comparing a length of the pattern with a set pattern pitch,
wherein the length of the pattern is derived by a difference in a coordinate value between a start point of a beginning of a coated portion and a coordinate value of an end point of an uncoated portion included in the pattern.

10. The method of claim 1, further comprises deriving a length of a coated portion included in the pattern by a difference in a coordinate value between a start point of a beginning of a coated portion and a coordinate value of an end point of the coated portion.

11. The method of claim 1, wherein, when an uncoated section not included in a pattern exists between neighboring patterns of the patterned electrode sheet, assigning a corresponding pattern indicator to the uncoated section by associating the uncoated section as a pattern by dividing a length of the uncoated section by a set pattern pitch.

12. The method of claim 2, wherein the monitoring data includes a roll map including the pattern indicator data and the measurement data and/or inspection data associated with the pattern indicators and further including coordinate data as an option.

13. A battery manufacturing system comprising:
A first position measuring device configured to generate pattern indicator data that includes representing a plurality of positions at a patterned electrode sheet in which coated portions and uncoated portions are repeatedly arranged, and a coated portion and an uncoated portion adjacent to the coated portion constituting a pattern, wherein a position of the plurality of positions being a position of at least one coated portion and an adjacent uncoated portion at the patterned electrode sheet;
a measuring device and/or inspecting device configured to collect measurement data and/or inspection data for the patterned electrode sheet; and
a server configured to generate monitoring data for manufacturing a battery based on the pattern indicator data and the measurement data and/or inspection data associated with the pattern indicator data.

14. The battery manufacturing system of claim 13, further comprising:
one or more processors;
the first position measuring device configured to generate the pattern indicator data including pattern indicators and time values matched to the pattern indicators;
the measuring device and/or inspecting device configured to generate the measurement values and/or inspection values, and time values matched to the measurement values and/or inspection values;
wherein the one or more processors are configured to associate the pattern indicators and the measurement values and/or inspection values with each other by corresponding to the same time value.

15. The battery manufacturing system of claim 13, wherein the first positioning measuring device is configured to generate the pattern indicator data including pattern indicators matching with the positions of the plurality of positions at the patterned electrode sheet, wherein a pattern indicator is generated by counting a position, the count increases or decreases with the pattern indicator.

16. The battery manufacturing system of claim 13, wherein the first position measuring device is configured to determine whether a pattern has an abnormal pitch by comparing a length of the pattern with a set pattern pitch.

17. The battery manufacturing system of claim 13, further comprising a second position measuring device configured to generate coordinate data including coordinate values indicating positions of the patterned electrode sheet,
wherein the coordinate values are associated with one or more of the following:
i) the pattern indicators;
ii) measurement values and/or inspection values included in the measurement data and/or inspection data; and
iii) time values matched to the pattern indicators and the measurement values and/or inspection values.

18. The battery manufacturing system of claim 11, further comprising a server configured to generate a roll map including the pattern indicator data and the measurement data and/or inspection data associated with the pattern indicator data and further include coordinate data as an option.

19. One or more non-transitory processor-readable mediums storing executable instructions therein, which when executed by one or more processors, causes the one or more processors to perform a method of claim 1.

20. A battery comprising:
an electrode having at least one coated portion and an adjacent uncoated portion represented by a pattern indicator of pattern indicator data that represents a plurality of positions at a roll map stored in a memory, the roll map representing a patterned electrode sheet in which coated portions and uncoated portions are repeatedly arranged, the roll map providing measurement data and/or inspection data of the coated portions at the represented pattern electrode sheet, and the pattern indicator indicating the position of at least one coated portion and the adjacent uncoated portion at the roll map corresponding to the electrode; and
a casing in which the electrode is contained, the casing including a cell ID, and the cell ID identifying the pattern indicator for retrieving measurement data and/or inspection data of the at least one coated portion at the represented electrode sheet corresponding to the pattern indicator.
